(19) United States
(12) Patent Application Publication
(10) Pub. No.: US 2012/0144960 A1
(43) Pub. Date: Jun. 14, 2012

(54) Hand Tool With An Adjustable Tool Head

(76) Inventor: Chin-Tan Huang, Taichung City (TW)

(21) Appl. No.: 13/102,011

(22) Filed: May 5, 2011

(30) Foreign Application Priority Data
Dec. 8, 2010 (TW) 099223793

(51) Int. Cl. B25B 23/16

(52) U.S. Cl. 81/177.8

(57) ABSTRACT

A hand tool includes a tool head with an insertion hingedly connected to a pair of lugs of a handle to be rotatable relative thereto, and retained to an angular position by means of a spring-biased ball. The insertion is configured to have a hemispherical segment which includes front and rear segment strips extending circumferentially from an apical area that has a retaining concavity. Each segment strips has a plurality of circumferentially extending retaining grooves. The hemispherical segment further includes left and right cutout surfaces parallel and opposite to each other. By virtue of the hemispherical segment, rotation of the tool head relative to the handle and engagement of the ball in a selected one of the grooves and concavity are smooth and successful.

### CROSS-REFERENCE TO RELATED APPLICATION

This application claims priority of Taiwanese Patent Application No. 099223793, filed on Dec. 8, 2010, the disclosure of which is herein incorporated by reference.

### BACKGROUND OF THE INVENTION

1. Field of the Invention

This invention relates to a hand tool, more particularly to a hand tool having a rotatable tool head which is adjustable relative to a handle.

2. Description of the Related Art

Referring to FIG. 1, a conventional hand tool includes a handle 1, a hinging bolt 2, and a tool head 3. The handle 1 has a pair of lugs 102 extending from a recessed end portion 101 thereof. A spring-biased ball 103 is disposed in the recessed end portion 101 and is biased toward a space between the lugs 102. The hinging bolt 2 extends through the lugs 102. The tool head 3 has a drive portion 302 for engaging a workpiece, and an insertion 301 which is pivotably connected to the lugs 102 by the hinging bolt 2 and which has an arcuate surface 303 and a plurality of retaining grooves 304 formed in the arcuate surface 303. By virtue of engagement between the spring-biased ball 103 and a selected one of the retaining grooves 304, the tool head 3 can be retained at a desired angular position relative to the handle 1. However, in order to facilitate smooth turning of the insertion 301 relative to the lugs 102 and successful engagement between the spring-biased ball 103 and a respective one of the retaining grooves 304, the insertion 301 needs to be machined so as to have rounded edges 305 at a periphery of each retaining groove 304. Thus, the manufacture of the conventional hand tool is relatively inconvenient and costly.

### SUMMARY OF THE INVENTION

An object of the present invention is to provide a hand tool which can be manufactured conveniently and relatively low costs.

According to this invention, the hand tool includes a handle having a handle body extending longitudinally to terminate at an end wall which has a recess, and a pair of lugs extending longitudinally from the end wall, spaced apart from each other along a joining axis to cooperate with the end wall to define a coupling space, and respectively having flanking surfaces, a spring-biased ball disposed in the recess and biased toward the coupling space, a tool head having a drive portion adapted for engaging a workpiece , and an insertion opposite to the drive portion in a lengthwise direction, and a hinging bolt fittingly extending through one flanking surface and the insertion along the joining axis so as to be fastened to the other flanking surface. The insertion is configured to have a hemispherical segment with a spherical center and a centerline that passes the spherical center. The hemispherical segment includes front and rear segment strips extending circumferentially about the centerline from an apical area that has a retaining concavity. Each of the front and rear segment strips has a plurality of circumferentially extending retaining grooves which are displaced from each other in the lengthwise direction. The hemispherical segment is prepared by a process which includes a step a) of providing the insertion of the tool head with a hemispherical body, and a step b) of machining the hemispherical body to form left and right cutout surfaces which are parallel and opposite to each other along the centerline, and which are disposed to confront the flanking surfaces, respectively, to bring the centerline in line with the joining axis.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary perspective view of a conventional hand tool;

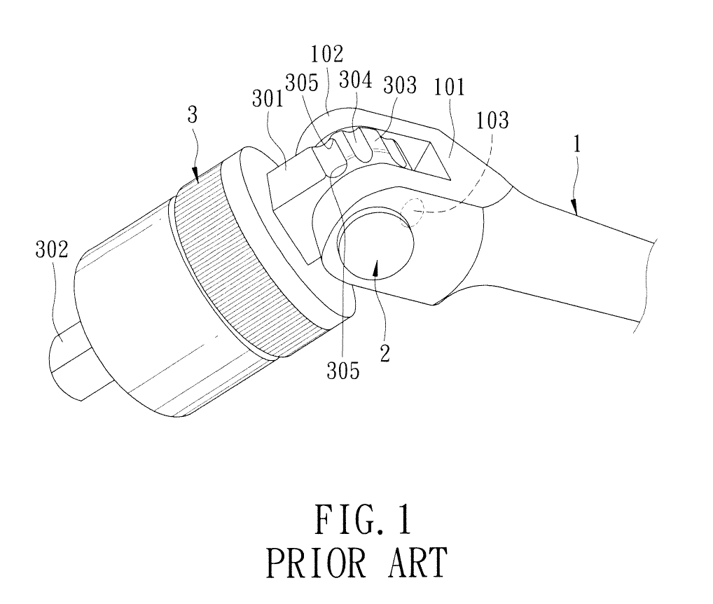

FIG. 2 is a fragmentary perspective view of the preferred embodiment of a hand tool according to this invention;

FIG. 3 is a fragmentary exploded perspective view of the preferred embodiment;

FIG. 4 is an exploded sectional view of a tool head of the preferred embodiment;

FIG. 5 is a fragmentary sectional view of the tool head of the preferred embodiment;

FIG. 6 is a sectional view taken along line VI-VI of FIG. 5;

FIG. 7 is a fragmentary side view of the preferred embodiment;

FIG. 8 is a fragmentary sectional view of the tool head in an angular position; and

FIG. 9 is a schematic view showing the process of producing a hemispherical body.

### DETAILED DESCRIPTION OF THE PREFERRED EMBODIMENT

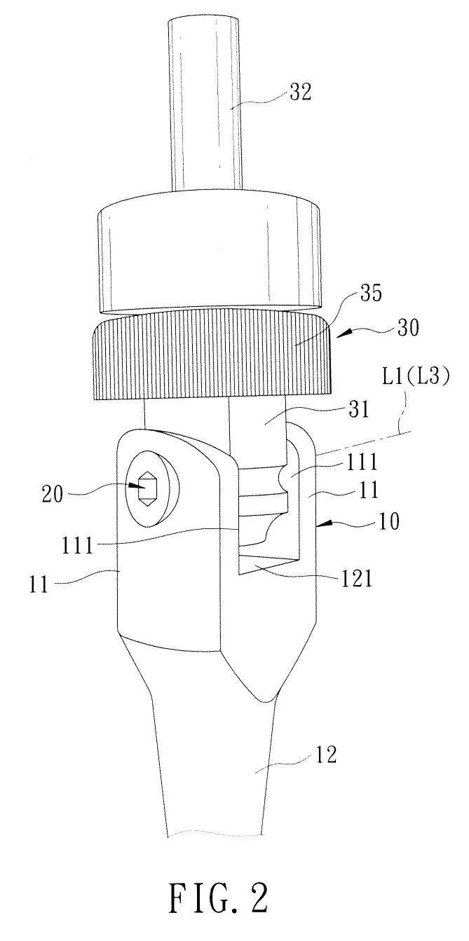

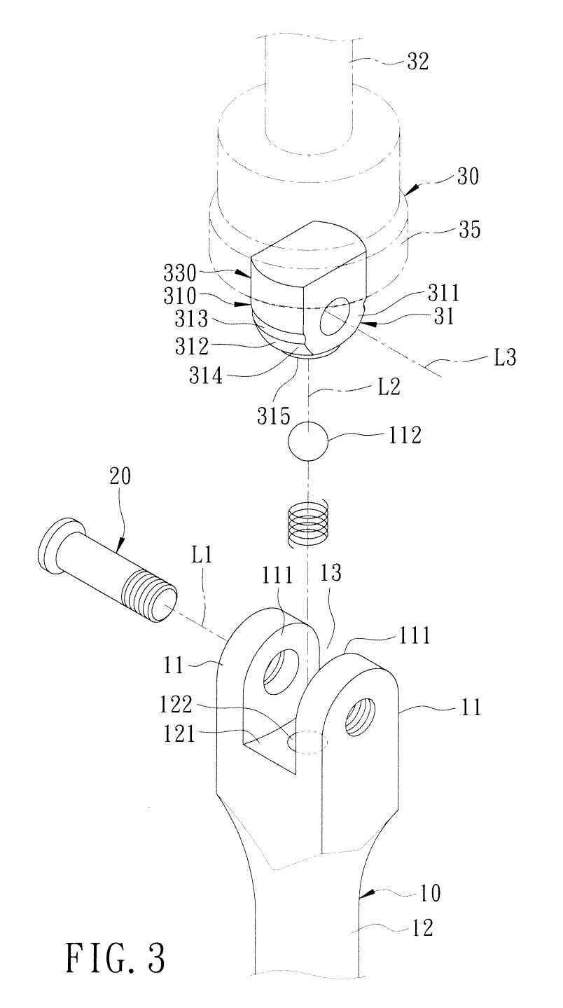

Referring to FIGS. 2 and 3, the preferred embodiment of a hand tool according to the present invention is shown to comprise a handle 10, a spring-biased ball 112, a tool head 30, and a hinging bolt 20.

The handle 10 has a handle body 12 extending longitudinally to terminate at an end wall 121 which has a recess 122, and a pair of lugs 11 extending longitudinally from the end wall 121 and spaced apart from each other along a joining axis (L1) to cooperate with the end wall 121 to define a coupling space 13. The lugs 11 respectively have flanking surfaces 111 which are spaced apart from each other by the coupling space 13.

The spring-biased ball 112 is disposed in the recess 122 and is biased toward the coupling space 13.

The tool head 30 has a drive portion 32 adapted for engaging a workpiece (not shown) , an insertion 31 opposite to the drive portion 32 along a lengthwise axis (L2) that is oriented in a lengthwise direction, and a ratchet unit interposed between the drive portion 32 and the insertion 31. Since the ratchet unit 35 is of a known type, description on it is dispensed with herein.

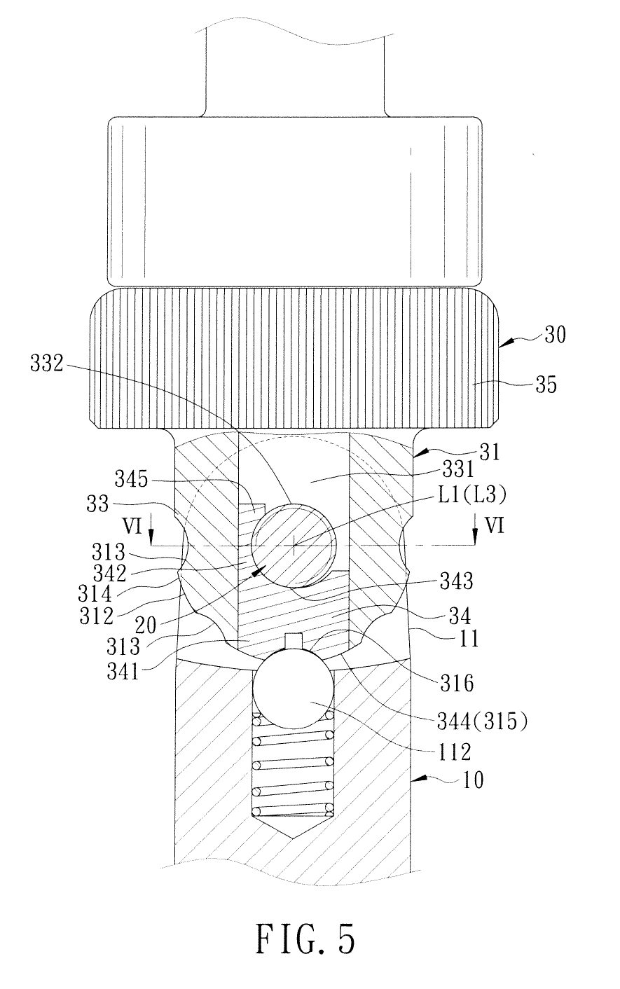

The insertion 31 is configured to have a straight segment 330 and a hemispherical segment 310. The hemispherical segment 310 defines a spherical center and a centerline (L3) that passes the spherical center and the lengthwise axis (L2). The hemispherical segment 310 includes front and rear segment strips 312 which are opposite to each other in a transverse direction that is transverse to both the lengthwise direction and the centerline (L3), and which extend in a circumferential direction about the centerline (L3) from an apical area 315 that has a retaining concavity 316 (see FIG. 5). Each of the front and rear segment strips 312 has a plurality of circumferentially extending retaining grooves 313 (two retaining grooves 313 in this embodiment) which are displaced from each other in the lengthwise direction and in the transverse direction. The hemispherical segment 310 further includes left and right cutout surfaces 311 which are parallel and opposite to each other along the centerline (L3), and which are disposed to confront the flanking surfaces 111 of the lugs 11, respectively, to bring the centerline (L3) in line with the joining axis (L1) . A guiding surface area 314 is disposed between two adjacent ones of the retaining grooves 313 and extends in a circumferential direction about the lengthwise axis (L2) to join the left and right cutout surfaces 311.

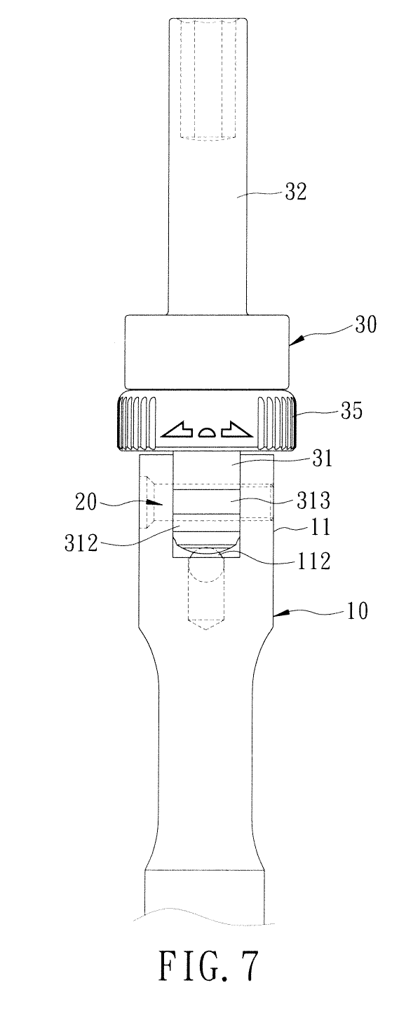

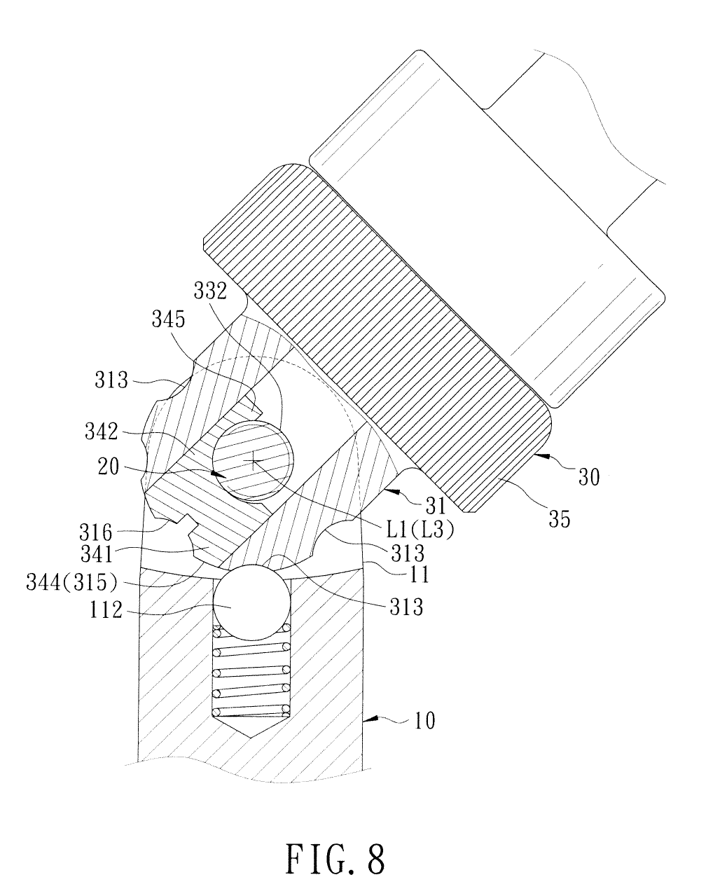

The hinging bolt 20 is fittingly inserted through the flanking surface 111 of one of the lugs 11, the left and right cutout surfaces 311 of the insertion 31 along the centerline (L3) so as to be fastened to the flanking surface 111 of the other one of the lugs 11. By virtue of manually forced displacement of the tool head 30 against the biasing action of the spring-biased ball 112, the tool head 30 is hingedly movable about the joining axis (L1) between a straight position, as shown in FIGS. 5 and 7, where the spring-biased ball 112 is engaged in the retaining concavity 316, and an angular position, as shown in FIG. 8, where the spring-biased ball 112 is engaged in a selected one of the retaining grooves 313.

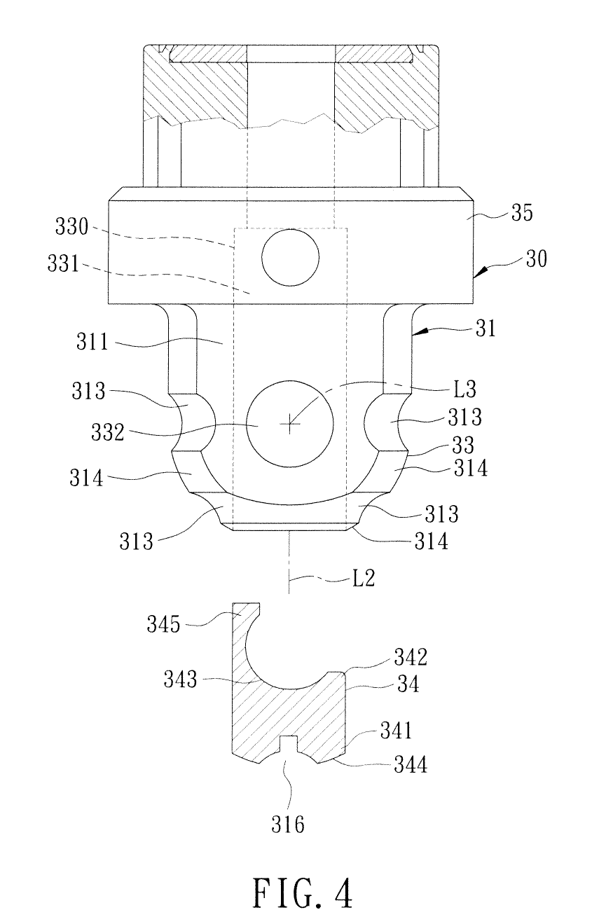

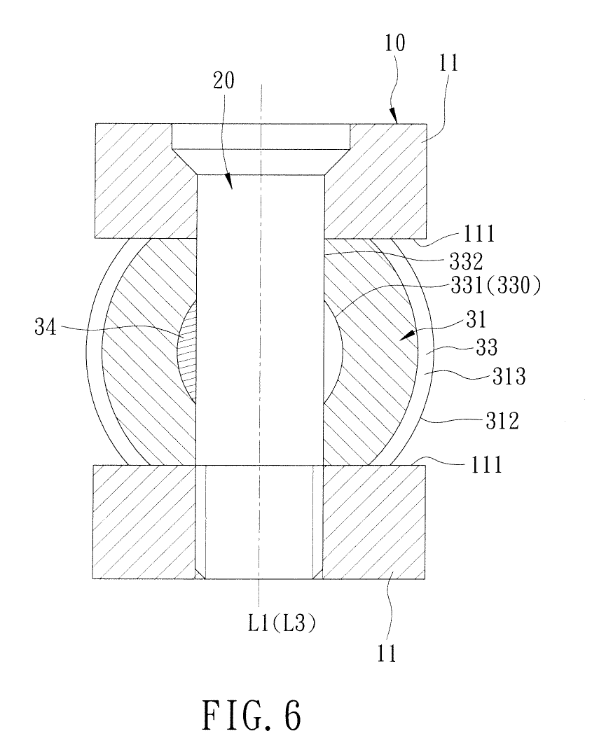

Referring to FIGS. 4 to 6, the hemispherical segment 310 is prepared by a process which includes a step a) of providing the insertion 31 of the tool head with a hemispherical body 33, and a step of b) of machining the hemispherical body 33 to form the left and right cutout surfaces 311. The hemispherical body 33 is made to have an inner tubular surface 330 that defines a lengthwise bore 331 extending along the lengthwise axis (L2), and a hinged hole 332 that extends along the centerline (L3) to communicate with the lengthwise bore 331 and through the left and right cutout surfaces 311. The hemispherical segment 310 is configured to further include an insert body 34 which is fitted into the lengthwise bore 331 and which has outer and inner portions 341, 342 opposite to each other in the lengthwise direction. The outer portion 341 has an outwardly convex surface 344 which extends outwardly of the lengthwise bore 331 to serve as the apical area 315, and which is formed with the retaining concavity 316. The inner portion 342 has a retained region 345 which is configured to be fittingly engaged in the lengthwise bore 331, and which has a cutout contour 343 configured to define a portion of the hinged hole 332 such that, when the hinging bolt 20 is inserted through the hinged hole 332, the retained region 345 is firmly held between the inner tubular surface 330 and the hinging bolt 20 so as to ensure a secured engagement of the insert body 34 in the lengthwise bore 331. The cross section of the cutout contour 343 may be configured to extend in the circumferential direction about the centerline (L3) by at least 180 degrees. Hence, the retaining concavity 316 is disposed to be spaced apart from the adjacent retaining grooves 313 in the front and rear segment strips 312 by an equal interval. By virtue of engagement of the spring-biased ball 112 in a selected one of the retaining grooves 313 and the retaining concavity 316, the tool head 30 is retained to a desired angular position relative to the handle 10. On the other hand, the tool head 30 can be manually operated to rotate relative to the handle 10 about the joining axis (L1) so as to adjust the angular position.

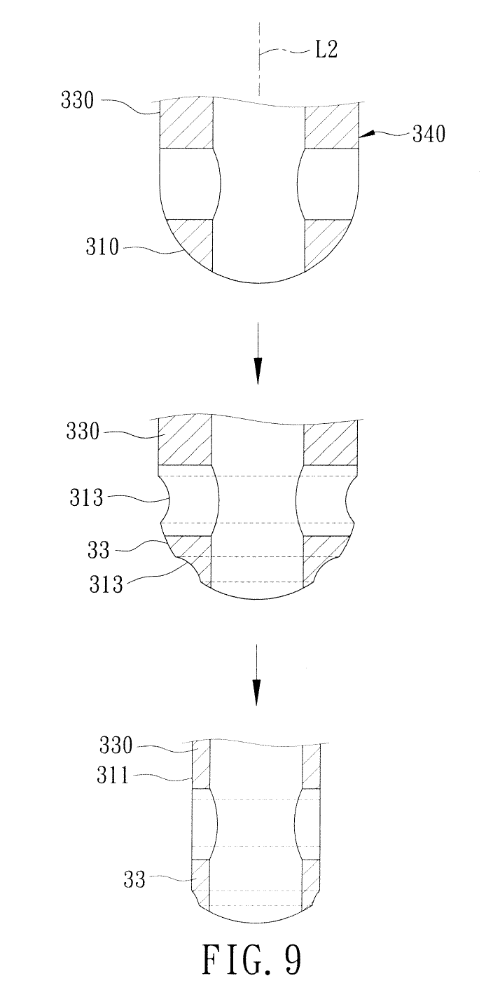

Further, referring to FIG. 9, the hemispherical body 33 is prepared from a hemispherical piece 340 which has a straight portion and a hemispherical portion that correspond to the straight segment 330 and the hemispherical segment 310. The hemispherical portion of the hemispherical piece 340 is firstly machined circumferentially about the lengthwise axis (L2) to produce the circumferentially extending retaining grooves 313 so as to form the hemispherical body 33. Subsequently, the hemispherical piece 340 is cut in the lengthwise direction to form the left and right cutout surfaces 311. As such, each of the retaining grooves 313 with desirably rounded edges at its periphery can be easily formed by virtue of a single machining process without any additional machining for edge rounding, while the smoothness of rotation of the tool head 30 relative to the handle 10 is not compromised. The assembly and fabrication of the insert body 34 are also easy to conduct so as to reduce the manufacturing costs of the hand tool.

It can be readily noted that, since each of the retaining grooves 313 and the guiding surface areas 314 extends circumferentially about the lengthwise axis (L2) and since the retaining concavity 316 extends circumferentially about the centerline (L3), the spring-biased ball 112 can be easily and successfully engaged in and disengaged from a selected one of the grooves 313 and the concavity 316, thereby facilitating rotation of the tool head 30 relative to the handle 10.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A hand tool comprising:
a handle having a handle body extending longitudinally to terminate at an end wall which has a recess, and a pair of lugs extending longitudinally from said end wall and spaced apart from each other along a joining axis to cooperate with said end wall to define a coupling space, said lugs respectively having flanking surfaces which are spaced apart from each other by said coupling space;
a spring-biased ball disposed in said recess and biased toward said coupling space;
a tool head having a drive portion adapted for engaging a workpiece, and an insertion opposite to said drive portion in a lengthwise direction, said insertion being configured to have a hemispherical segment with a spherical center and a centerline that passes the spherical center, said hemispherical segment including front and rear segment strips which extend in a circumferential direction about the centerline from an apical area that has a retaining concavity, each of said front and rear segment strips having a plurality of circumferentially extending retaining grooves which are displaced from each other in the lengthwise direction, said hemispherical segment being prepared by a process which includes a step a) of providing said insertion of said tool head with a hemispherical body, and a step b) of machining said hemispherical body to form left and right cutout surfaces which are parallel and opposite to each other along the centerline, and which are disposed to confront said flanking surfaces, respectively, to bring the centerline in line with the joining axis; and
a hinging bolt fittingly extending through one of said flanking surfaces, said left and right cutout surfaces along the centerline so as to be fastened to the other one of said flanking surfaces such that, by virtue of manually forced displacement of said tool head against biasing action of said spring-biased ball, said tool head is hingedly movable about the joining axis between a straight position, where said spring-biased ball is engaged in said retaining concavity, and an angular position, where said spring-biased ball is engaged in a selected one of said retaining grooves.

2. The hand tool according to claim 1, wherein each of said front and rear segment strips has a plurality of guiding surface areas, each of which is defined between two adjacent ones of said retaining grooves and each of which extends in a circumferential direction about a lengthwise axis oriented in the lengthwise direction to join said left and right cutout surfaces.

3. The hand tool according to claim 2, wherein said hemispherical segment has
an inner tubular surface that defines a lengthwise bore extending along the lengthwise axis, and a hinged hole that extends along the centerline to communicate with said lengthwise bore and through said left and right cutout surfaces, and
an insert body which is fitted into said lengthwise bore and which has outer and inner portions opposite to each other in the lengthwise direction, said outer portion having an outwardly convex surface which extends outwardly of said lengthwise bore to serve as said apical area, and which is formed with said retaining concavity, said inner portion having a retained region which is configured to be fittingly engaged in said lengthwise bore, and which has a cutout contour configured to define a portion of said hinged hole such that, when said hinging bolt is inserted through said hinged hole, said retained region is firmly held between said inner tubular surface and said hinging bolt so as to ensure a secured engagement of said insert body in said lengthwise bore.

4. The hand tool according to claim 3, wherein the cross section of said cutout contour is configured to extend in the circumferential direction about the centerline by at least 180 degrees.

5. The hand tool according to claim 3, wherein said circumferentially extending retaining grooves are produced by performing, before the step b) , a step c) of machining said hemispherical body circumferentially about the lengthwise axis.
